(19) United States
(12) Patent Application Publication
(10) Pub. No.: US 2010/0303930 A1
(43) Pub. Date: Dec. 2, 2010

(54) N-HALAMINE FORMULATIONS WITH ENHANCED ANTIMICROBIAL ACTIVITY

(75) Inventors: Thomas Christopher Carey, Fort Worth, TX (US); Nissanke L. Dassanayake, Fort Worth, TX (US); Ronald L. Schlitzer, Fort Worth, TX (US); Howard Allen Ketelson, Dallas, TX (US)

Correspondence Address: ALCON, IP LEGAL, TB4-8, 6201 SOUTH FREEWAY, FORT WORTH, TX, 76134, US

(73) Assignee: ALCON RESEARCH, LTD., Fort Worth, TX (US)

(21) Appl. No.: 12/789,965

(22) Filed: May 28, 2010

Related U.S. Application Data
(60) Provisional application No. 61/182,539, filed on May 29, 2009.

(51) Int. Cl. A01N 59/08; A01P 1/00

(52) U.S. Cl. 424/665

(57) ABSTRACT

The present invention relates to antimicrobial formulations comprising an N-halamine and a quantity of sodium chlorite sufficient to enhance the antimicrobial efficacy of the N-halamine. The present invention is further directed to formulations for disinfecting a contact lens comprising an N-halamine and a quantity of sodium chlorite sufficient to enhance the antimicrobial efficacy of the N-halamine.

### CROSS-REFERENCE TO RELATED APPLICATION

This application claims priority under 35 U.S.C. §119 to U.S. Provisional Patent Application No. 61/182,539, filed May 29, 2009, the entire contents of which are incorporated herein by reference.

### TECHNICAL FIELD OF THE INVENTION

The present invention relates to methods for enhancing the antimicrobial efficacy of N-halamine compounds in aqueous formulations. The present invention further relates to formulations for contact lens cleaning and disinfection comprising N-halamine compounds and a chlorite compound such as sodium chlorite.

### BACKGROUND OF THE INVENTION

Compounds possessing antimicrobial activity are used in a variety of applications such as surface disinfection, solution preservation, and therapeutic treatments. For applications such as the disinfection of tissues, medical devices, and contact lenses, there is an ongoing need for formulations with good safety profiles and antimicrobial efficacy. In general, it is desirable to use antimicrobial compounds at as low a concentration as possible to minimize harmful side effects, while ensuring that the compounds have the desired antimicrobial efficacy.

There is also a need for an improved means of preserving pharmaceutical compositions from microbial contamination. This need is particularly prevalent in the fields of ophthalmic and otic compositions. The antimicrobial utilized to preserve aqueous ophthalmic and otic compositions must be effective in preventing microbial contamination of the compositions when used at concentrations that are non-toxic to ophthalmic and otic tissues.

Many halogenated amine compounds have demonstrated efficacy as disinfectants and biocides and have good safety profiles. For example, chloramine compounds have been shown to be useful as contact lens disinfectants. See U.S. Pat. No. 4,780,152 to Itagaki et al. The disinfection of contact lenses is required to avoid the buildup of infectious and non-infectious contaminants on the contact lens surfaces. Daily cleaning and disinfection may be necessary, particularly for hydrophilic (soft) contact lenses. The failure to clean and disinfect lenses properly has consequences for a lens wearer ranging from eye irritation to serious infections. Ocular infections caused by particularly virulent microbes, such as P. aeruginosa, can lead to loss vision if left untreated or if allowed to reach an advanced stage before treatment is initiated.

U.S. Pat. No. 4,931,562 to Akabane discloses certain N-halamine compounds that are useful for bleaching and industrial applications. U.S. Pat. No. 5,902,818 and U.S. Pat. No. 6,020,491 disclose that certain N-halamines are useful biocides. These references do not disclose the combination of an N-halamine and a chlorite compound in an aqueous formulation.

### BRIEF SUMMARY OF THE INVENTION

The present invention is directed in certain embodiments to methods for enhancing the antimicrobial efficacy of N-halamine compounds in aqueous formulations. The enhancement is achieved by combining an N-halamine with a chlorite compound such as sodium chlorite, as described herein.

The present invention further relates to aqueous ophthalmic formulations having antimicrobial activity that comprise N-halamine compounds and a chlorite compound such as sodium chlorite.

One embodiment of the present invention is a method for disinfecting and/or cleaning a contact lens comprising contacting a contact lens with an aqueous formulation comprising a N-halamine of the present invention and a chlorite compound for a time sufficient to disinfect and/or clean the lens.

Yet another embodiment is an aqueous pharmaceutical composition comprising an N-halamine and a chlorite compound in a quantity sufficient to preserve the composition.

The foregoing brief summary broadly describes the features and technical advantages of certain embodiments of the present invention. Additional features and technical advantages will be described in the detailed description of the invention that follows. Novel features which are believed to be characteristic of the invention will be better understood from the detailed description of the invention.

### DETAILED DESCRIPTION OF THE INVENTION

The present inventors have discovered that the N-halamines of the present invention have enhanced antimicrobial properties when present in an aqueous composition comprising a concentration of a chlorite compound such as sodium chlorite. When combined in an aqueous formulation, the combination of an N-halamine with a chlorite compound such as sodium chlorite appears to result in a beneficial synergistic effect on the formulation's antimicrobial properties. As used herein, the term “antimicrobial” refers to the ability to kill or inhibit the growth of microbes (to include, without limitation, bacteria, viruses, yeast, fungi, spores, protozoa, parasites, etc.).

The N-halamines used in the formulations of the present invention have a structure according to the following Formula (I)

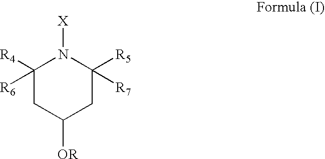

where R═H,

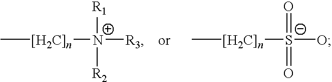

n=1−10;
X═Cl, Br, or I;
R₁, R₂, and R₃ are, independently, H, CH₃, C₂H₅, or C₃H₇; and R₄, R₅, R₆, and R₇ are, independently, H, CH₃, C₂H₅, C₃H₇ or t-butyl. Pharmaceutically acceptable salts of the N-halamines of the present invention are also contemplated for use in embodiments of the present invention. Such salts may include, but are not limited to, those formed by combination with halide anions such as chloride or bromide, phosphates, alkali cations, and quaternary ammonium cations. A preferred N-halamine of the present invention is 1-chloro-2,2,6,6-tetramethyl-4-piperidinol where R═H and X═Cl.

N-halamines of the present invention may be prepared using synthetic methods known to those of skill in the art. In addition, publications are available that describe other methods that may be used to synthesize compounds of the present invention. These publications include the Zakrewski J., “A simple method for the synthesis of sterically hindered chloramines”, Synthetic Communications, Vol. 18(16&17):2135-2140 (1988), herein incorporated by reference in its entirety. A general method for synthesis uses a reaction between sodium chlorite or sodium hypochlorite and piperidinol to form N-chloropiperidinol. Generally, the formulations of the present invention comprise an N-halamine at a concentration of 0.001 to 0.1 w/v % in aqueous solution, with a most preferred concentration of 0.006 w/v %.

The formulations of the present invention additionally comprise a chlorite compound in a quantity sufficient to enhance the antimicrobial efficacy of the N-halamine compound. Preferred chlorite compounds are alkali metal chlorites such as sodium or potassium chlorite, transition metal chlorites, and stabilized sodium chlorite. Sigma-Aldrich Company (St. Louis, Mo.) sells an 80% solution of sodium chlorite with sodium chlorate. Certain stabilized sodium chlorite products are commercially available (e.g., PURITE and ANTHIUM DIOXIDE). Sodium chlorite can be easily obtained commercially (e.g., ADOX). Generally, the chlorite compound is present at a concentration that has minimal antimicrobial activity by itself, but provides synergistic enhancement of the antimicrobial effects of the N-halamine. A preferred concentration range for the chlorite compound in formulations of the present invention is 0.001 to 0.010 w/v %, with a most preferred concentration of 0.006 w/v %.

In addition to an N-halamine, the formulations of the present invention optionally comprise one or more additional components. Such components include, but are not limited to, tonicity agents, preservatives, chelating agents, buffering agents, surfactants, co-solvents, and antioxidants. Other components used in certain embodiments are solubilizing agents, stabilizing agents, comfort-enhancing agents, polymers, emollients, pH-adjusting agents and/or lubricants. Components that may be used in certain formulations of the present invention including water, mixtures of water and water-miscible solvents, such as C1-C7-alkanols, vegetable oils or mineral oils comprising from 0.5 to 5% non-toxic water-soluble polymers, natural products, such as alginates, pectins, tragacanth, karaya gum, xanthan gum, carrageenin, agar and acacia, starch derivatives, such as starch acetate and hydroxypropyl starch, and also other synthetic products, such as polyvinyl alcohol, polyvinylpyrrolidone, polyvinyl methyl ether, polyethylene oxide, preferably cross-linked polyacrylic acid, and mixtures of those products.

In addition to an N-halamine compound of Formula (I) and a chlorite compound, the compositions of the present invention may comprise additional compounds having antimicrobial properties. Suitable antimicrobial agents include, but are not limited to those generally used in contact lens care solutions or in other ophthalmic solutions such as polyquaternium-1, which is a polymeric quaternary ammonium compound; myristamidopropyl dimethylamine (“MAPDA”), which is a N,N-dialkyl, N′-alkyl, ethylene diamine; polyhexamethylene biguanide (“PHMB”) or polyaminopropyl biguanide (PAPB), which is a polymeric biguanide; and hydrogen peroxide. The additional antimicrobial agents that may be utilized in the present invention also include the aminobiguanides described in U.S. Pat. No. 6,664,294, the entire contents of which are hereby incorporated in the present specification by reference. The preferred additional antimicrobial agents are polyquaternium-1, MAPDA and the amino biguanide identified in U.S. Pat. No. 6,664,294 as “Compound Number 1”.

Suitable antioxidants include, but are not limited to, sulfites, ascorbates, butylated hydroxyanisole (BHA) and butylated hydroxytoluene (BHT).

Stabilizing agents including phosphonic acid and its derivatives such as Dequest, chelating agents to remove trace metals, phosphates such as tetrabutyl ammonium phosphate, and quaternary ammonium compounds such as tetrabutyl ammonium chloride and tetrabutyl ammonium hydroxide.

Surfactants utilized in the compositions of the present invention can be cationic, anionic, nonionic or amphoteric. Preferred surfactants are neutral or noninonic surfactants which may present in amounts up to 5 w/v %. Surfactants that may be used with certain embodiments of the present invention include, but are not limited to, polyethylene glycol ethers or esters of fatty acids, polyoxyethylene-polyoxypropylene block copolymers of ethylene diamine (e.g., poloxamines such as Tetronic 1304 or 1107), polyoxypropylene-polyoxyethylene glycol nonionic block copolymers (e.g., poloxamers, such as Pluronic F-127), p-isooctylpolyethylen phenol formaldehyde polymers (e.g., Tyloxapol), and Pluronix and Tetronic R derivatives such as Pluronic 17R.

In certain embodiments of the present invention, suitable cosolvents include glycerin, propylene glycol and polyethylene glycol.

Buffering agents which may be incorporated into formulations of the present invention include, but are not limited to, alkaline metal salts, such as potassium or sodium carbonates, acetates, borates, phosphates and citrates, and weak acids, such as acetic acids and boric acids. The preferred buffering agents are alkaline metal borates, such as sodium or potassium borates. Other pH-adjusting agents, such as inorganic acids and bases, may also be utilized. For example, hydrochloric acid or sodium hydroxide may be employed in concentrations suitable for ophthalmic compositions. The above-described buffering agents are generally present in amounts from about 0.1 to about 2.5 w/v %, preferably from about 0.5 to about 1.5% w/v %.

The formulations of the present invention are preferably isotonic, or slightly hypotonic, and generally have an osmolality in the range of 210-320 mOsm/kg, and preferably have an osmolality in the range of 235-300 mOsm/kg. This may require a tonicity agent to bring the osmolality of the formulation to the desired level. Tonicity-adjusting agents include, but are not limited to, sodium chloride, glycerin, sorbitol, or mannitol.

The formulations set forth herein may comprise one or more preservatives. Examples of preservatives include p-hydroxybenzoic acid ester, alkyl-mercury salts of thiosalicylic acid, such as, for example, thiomersal, phenylmercuric nitrate, phenylmercuric acetate or phenylmercuric borate, quaternary ammonium compounds such as, for example, polyquaternium-1, sodium perborate, sodium chlorite (and combinations with sodium perborate), parabens, such as, for example, methylparaben or propylparaben, alcohols, such as, for example, chlorobutanol, benzyl alcohol or phenyl ethanol, guanidine derivatives, such as, for example, polyhexamethylene biguanide, sodium perborate, or sorbic acid. In preferred embodiments, the formulation may be self-preserved that no preservation agent is required.

In contact lens disinfection applications, it is imperative that the disinfection activity of a formulation of the present invention should be maximized so that a minimum amount of active ingredient is used. The amount of the N-halamine and the chlorite compound required to achieve the desired disinfection activity can be determined by persons skilled in the art. The concentration required to achieve the desired activity as a disinfectant while retaining acceptable safety and toxicity properties is referred to herein as “an effective amount”. An effective amount will possess antimicrobial activity sufficient to meet generally accepted standards for activity, such as EN ISO 14729:2001 Ophthalmic optics—Contact lens care products—Microbiological requirements and test methods for products and regimens for hygienic management of contact lenses.

It is also contemplated that the concentrations of the compounds (including, but not limited to N-halamines) comprising the formulations of the present invention can vary. A person of ordinary skill in the art would understand that the concentrations can vary depending on the addition, substitution, and/or subtraction of ingredients in a given formulation. In non-limiting aspects, the percentage can be calculated by weight or volume of the total formulation.

For ophthalmic applications, the pH of the formulations generally is in an ophthalmically acceptable range of 6.0 to 8.0. Preferred ophthalmic formulations are prepared using a buffering system that maintains the formulation at a pH of about 6.5 to a pH of about 7.8.

In certain contact lens disinfection applications, a pH range of 3.0 to 8.0 is utilized as part of an indicator system. At pH ranges of lower than about 6.0, N-halamine and chlorite aqueous formulations can develop a yellow color due to the formation of chlorine dioxide. The presence or absence of coloration can be used as an indicator of the progress of contact lens disinfection. If the pH is returned to a more neutral value such as 6.0 to 8.0 via oxidation reactions over a given time or via neutralization of the N-halamine or chlorite using a tablet containing a neutralization compound such as sodium perborate, the yellow colorization due to chlorine dioxide is eliminated. Thus, the change from a yellow formulation to a clear formulation can be used as an indication that the formulation is no longer active or that the contact lens disinfection process has been completed.

In particular embodiments, formulations of the present invention are suitable for topical application to mammalian eyes. For example, for ophthalmic administration, the formulation may be a solution, a suspension, a gel, water-in-oil and oil-in-water emulsions, or an ointment. Preferred formulations for ophthalmic administration will be aqueous solution in the form of drops. The term “aqueous” typically denotes an aqueous formulation wherein the excipient is >50%, more preferably >75% and in particular >90% by weight water. These drops may be delivered from a single dose ampoule which may preferably be sterile and thus render bacteriostatic components of the formulation unnecessary. Alternatively, the drops may be delivered from a multi-dose bottle which may preferably comprise a device which extracts preservative from the formulation as it is delivered, such devices being known in the art.

In certain topical ophthalmic applications, the N-halamine compound may be formulated in a formulation that comprises one or more tear substitutes. A variety of tear substitutes are known in the art and include, but are not limited to: monomeric polyols, such as, glycerol, propylene glycol, and ethylene glycol; polymeric polyols such as polyethylene glycol; cellulose esters such hydroxypropylmethyl cellulose, carboxy methylcellulose sodium and hydroxy propylcellulose; dextrans such as dextran 70; vinyl polymers, such as polyvinyl alcohol; and carbomers, such as carbomer 934P, carbomer 941, carbomer 940 and carbomer 974P. Ophthalmic formulations for in situ disinfection generally have a viscosity of 0.5-100 cps, preferably 0.5-50 cps, and most preferably 1-20 cps. This relatively low viscosity insures that the product is comfortable, does not cause blurring, and is easily processed during manufacturing, transfer and filling operations.

Certain embodiments of the present invention comprise an N-halamine of the present invention in a tablet form with a chlorite compound. A tablet form of the present invention may comprise in addition to an N-halamine and a chlorite one or more excipients, binders, neutralizing agents and controlled release agents such as Eudgragit, HPMC, pharmacoat 603, simeticon, macrogolum 6000, trisodium phosphate monohydrate, sodium ascorbate, sodium borohydride, and lactose monohydrate. U.S. Pat. No. 6,440,411 to Scherer et al., herein incorporated by reference in its entirety, discloses the generation of tablets that may be used with the N-halamines and chlorites of the present invention. The tablets may be added to water or an aqueous solution to form a disinfecting aqueous solution that may be used, for example, as a contact lens disinfectant. These tablets may be added to aqueous solutions (such as peroxide or sodium perborate solutions) that slowly neutralize the N-halamine and/or chlorite over a period of time to allow for disinfection yet result in a formulation suitable for installation into an eye following neutralization. An indicator system as described above can be utilized with certain of these embodiments.

### EXAMPLES

The following examples are presented to further illustrate selected embodiments of the present invention.

### Example 1

| Ingredient | % w/v |
|---|---|
| 1-chloro-2,2,6,6-tetramethyl-4-piperidinol | 0.006 |
| Pluronic 17R4 | 0.05 |
| Boric Acid | 0.35 |
| Sodium Borate | 0.11 |
| Sodium Chloride | 0.7 |
| Sodium Chlorite | 0.006 |
| Sodium Hydroxide/Hydrochloric Acid | pH adjust to 7.0 |
| Purified Water | QS |

### Example 2

The antimicrobial activity of N-halamine formulations with and without the addition of sodium chlorite are compared. TABLE 1 below presents the results of the experiments. All concentrations in the tables below are in w/v% unless otherwise indicated. Total chlorine was also measured using a common technique known to those of skill in the art.

TABLE 1 presents data showing that the N-halamine of the present invention had good antimicrobial activity against S. aureus by itself, but was not as effective against C. albicans and S. marcescens at lower concentrations in formulations 2 and 3. When sodium chlorite is added to the formulations, almost no microbe survivors were recovered from any of the samples tested using formulations 4-7. TABLE 2 compared the antimicrobial efficacy of solutions comprising either an N-halamine or a chlorite. While the chlorite formulations (formulations 11-14) showed weak activity against S. aureus, they are not effective disinfectants at the concentrations tested. The N-halamine formulations tested (formulations 8-10) showed better efficacy than the chlorite formulations, but were not very effective against C. albicans at the concentrations tested. In sum, the data demonstrates the synergistic antimicrobial properties of the formulations of the present invention.

TABLE 1

| Component | 1 | 2 | 3 | 4 | 5 | 6 | 7 |
|---|---|---|---|---|---|---|---|
| 1-chloro-2,2,6,6-tetramethyl- | 0.0125 | 0.006 | 0.003 | 0.006 | 0.003 | 0.006 | 0.003 |
| 4-piperidinol | | | | | | | |
| Available chlorine (ppm) | 79 | 53 | 62 | 265 | 283 | 265 | 239 |
| Pluronic 17R4 | | | | | | 0.05 | 0.05 |
| Boric Acid | 0.35 | 0.35 | 0.35 | 0.35 | 0.35 | 0.35 | 0.35 |
| Sodium Borate | 0.11 | 0.11 | 0.11 | 0.11 | 0.11 | 0.11 | 0.11 |
| Sodium Chloride | 0.7 | 0.7 | 0.7 | 0.7 | 0.7 | 0.7 | 0.7 |
| Sodium Chlorite | | | | 0.006 | 0.006 | 0.006 | 0.006 |
| Assay (Sodium Chlorite) | | | | 110 | 110 | 117 | 107 |
| pH | 7.0 | 7.0 | 7.0 | 7.0 | 7.0 | 7.0 | 7.0 |
| Osmolality (mOs/kg) | 295 | 295 | 295 | 295 | 295 | 293 | 293 |

| | Time | | | | | | | |
|---|---|---|---|---|---|---|---|---|
| Microorganism | (hrs) | 1 | 2 | 3 | 4 | 5 | 6 | 7 |
| C. albicans | 6 | *6.1 | 2.4 | 0.3 | 6.1 | 6.1 | 6.1 | 2.0 |
| 1.2 × 10^{6b} | 24 | 6.1 | 6.1 | 6.1 | 6.1 | 6.1 | 6.1 | 6.1 |
| S. marcescens | 6 | 6.1 | 5.4 | 3.0 | 6.1 | 6.1 | 6.1 | 6.1 |
| 1.3 × 10⁶ | 24 | 6.1 | 6.1 | 6.1 | 6.1 | 6.1 | 6.1 | 6.1 |
| S. aureus | 6 | 6.2 | 6.2 | 6.2 | 6.2 | 6.2 | 6.2 | 6.2 |
| 1.5 × 10⁶ | 24 | 6.2 | 6.2 | 6.2 | 6.2 | 6.2 | 6.2 | 6.2 |

^{c} Underlined number indicates no survivors (<10 CFU/mL) recovered

TABLE 2

| Component | | 8 | 9 | 10 | 11 | 12 | 13 | 14 |
|---|---|---|---|---|---|---|---|---|
| 1-chloro-2,2,6,6-tetramethyl- | | 0.0005 | 0.001 | 0.002 | | | | |
| 4-piperidinol | | | | | | | | |
| Pre-test assay, ppm | | 5 | 10.8 | 23 | | | | |
| Post-test assay, ppm | | 4 | 9.7 | 22.5 | | | | |
| Boric Acid | | 0.35 | 0.35 | 0.35 | 0.35 | 0.35 | 0.35 | 0.35 |
| Sodium Borate | | 0.11 | 0.11 | 0.11 | 0.11 | 0.11 | 0.11 | 0.11 |
| Sodium Chloride | | 0.7 | 0.7 | 0.7 | 0.7 | 0.7 | 0.7 | 0.7 |
| Sodium Chlorite | | | | | 0.001 | 0.0025 | 0.004 | 0.006 |
| Pre-test assay (sodium | | | | | 12.9 | 21.6 | 46.6 | 88.8 |
| chlorite) | | | | | | | | |
| Post test assay (sodium | | | | | 11.1 | 20.1 | 45.9 | 97.4 |
| chlorite) | | | | | | | | |
| pH | | 7.03 | 6.98 | 6.97 | 6.98 | 7.1 | 7.0 | 7.0 |
| Osmolality | | 285 | 282 | 275 | 281 | 280 | 284 | 286 |
| | Time | Log₁₀ Reduction of Survivors | | | | | | |
| Microorganism | (hrs) | 8 | 9 | 10 | 11 | 12 | 13 | 14 |
| C. albicans | 6 | −0.2 | −0.1 | 0.4 | −0.2 | −0.1 | −0.2 | −0.2 |
| 9.5 × 10^{5b} | 24 | 0.1 | 1.2 | 4.8 | −0.2 | −0.1 | −0.2 | −0.2 |
| S. marcescens | 6 | 0.4 | 1.8 | 3.2 | 0.1 | 0.2 | 0.2 | 0.3 |
| 1.1 × 10⁶ | 24 | 3.1 | 5.0 | 6.0 | 0.4 | 0.5 | 1.1 | 3.8 |
| S. aureus | 6 | 2.9 | 3.9 | 6.1 | −0.2 | −0.1 | −0.1 | 0.3 |
| 1.3 × 10⁶ | 24 | *6.1 | 6.1 | 6.1 | 2.2 | 4.0 | 6.1 | 6.1 |

^{c} Underlined number indicates no survivors (<10 CFU/mL) recovered

The present invention and its embodiments have been described in detail. However, the scope of the present invention is not intended to be limited to the particular embodiments of any process, manufacture, composition of matter, compounds, means, methods, and/or steps described in the specification. Various modifications, substitutions, and variations can be made to the disclosed material without departing from the spirit and/or essential characteristics of the present invention. Accordingly, one of ordinary skill in the art will readily appreciate from the disclosure that later modifications, substitutions, and/or variations performing substantially the same function or achieving substantially the same result as embodiments described herein may be utilized according to such related embodiments of the present invention. Thus, the following claims are intended to encompass within their scope modifications, substitutions, and variations to processes, manufactures, compositions of matter, compounds, means, methods, and/or steps disclosed herein.

1. A sterile, aqueous ophthalmic composition comprising an N-halamine of Formula (I): 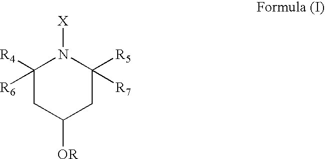
where R═H, 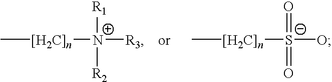
n=1−10;
X═Cl, Br, or I;
R₁, R₂, and R₃ are, independently, H, CH₃, C₂H₅, or C₃H₇;
R₄, R₅, R₆, and R₇ are, independently, H, CH₃, C₂H₅, C₃H₇ or t-butyl;
or a pharmaceutically acceptable salt thereof, and a quantity of sodium chlorite sufficient to enhance the antimicrobial efficacy of the N-halamine and a pharmaceutically acceptable vehicle therefor.

2. A composition according to claim 1 wherein said N-halamine is 1-chloro-2,2,6,6-tetramethyl-4-piperidinol.

3. A composition according to claim 1 wherein said N-halamine is present at a concentration of from 0.0001 to 0.1 w/v % and said chlorite compound is present at a concentration of 0.001 to 0.01 w/v %.

4. A composition according to claim 3 wherein said N-halamine is present at a concentration of from 0.005 to 0.01 w/v % and said chlorite compound is present at a concentration of 0.001 to 0.01 w/v %.

5. A composition according to claim 1 wherein said N-halamine is 1-chloro-2,2,6,6-tetramethyl-4-piperidinol and said chlorite is sodium chlorite.

6. A composition according to claim 5 wherein said N-halamine is present at a concentration of 0.006 and said sodium chlorite is present at a concentration of 0.006.

7. A composition according to claim 1 wherein said N-halamine and said chlorite compound are present in a quantity sufficient to preserve said composition.

8. A method for disinfecting and/or cleaning a contact lens comprising:
contacting a contact lens with a composition according to claim 1.

9. A method according to claim 8 wherein said composition has a pH of 6.0 to 8.0

10. A method according to claim 9 wherein said composition has a pH of 6.5 to 7.8.

11. A disinfecting tablet soluble in aqueous solution, said tablet comprising an N-halamine of Formula (I) 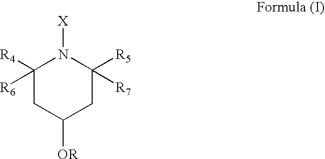
where R═H, 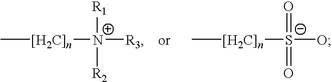
n=1−10;
X═Cl, Br, or I;
R₁, R₂, and R₃ are, independently, H, CH₃, C₂H₅, or C₃H₇;
R₄, R₅, R₆, and R₇ are, independently, H, CH₃, C₂H₅, C₃H₇ or t-butyl; or a pharmaceutically acceptable salt thereof, and
a quantity of sodium chlorite sufficient to enhance the antimicrobial efficacy of the N-halamine when dissolved in aqueous solution and a pharmaceutically acceptable vehicle therefor.

12. A method for disinfecting surfaces comprising:
contacting the surface to be disinfected with a composition according to claim 1.
